(19) United States
(12) Patent Application Publication
(10) Pub. No.: US 2015/0186419 A1
(43) Pub. Date: Jul. 2, 2015

(54) STYLE RECOMMENDATION ENGINE AND METHOD

(71) Applicant: Vandana Agrawal, Saratoga, CA (US)

(72) Inventor: Vandana Agrawal, Saratoga, CA (US)

(21) Appl. No.: 14/145,860

(22) Filed: Dec. 31, 2013

(51) Int. Cl. G06F 17/30

(52) U.S. Cl. CPC G06F 17/30247

(57) ABSTRACT

The present invention relates generally to a computer-implemented method and system for generating recommendations of style. In one preferred embodiment, this recommendation of style may include a recommendation for an article of clothing wherein the recommendation may include elements of fit, cut, label, etc.

### RELATED APPLICATIONS

This application claims benefit of priority to U.S. Provisional Patent Application No. 61/747,414, entitled STYLE RECOMMENDATION ENGINE AND METHOD, filed Dec. 31, 2012, the aforementioned priority application being hereby incorporated by reference in its entirety.

### TECHNICAL FIELD

The disclosed embodiments relate generally to a computer-implemented method for recommending to a consumer different style options as it relates to their choices in personal clothing.

### BACKGROUND ART

Digital photography has become a consumer application of great significance. It has afforded individuals convenience in capturing and sharing digital images. Devices that capture digital images have become low-cost, and the ability to send pictures from one location to the other has been one of the driving forces in the drive for more network bandwidth.

Due to the relative low cost of memory and the availability of devices and platforms from which digital images may be viewed, the average consumer maintains most digital images on computer-readable mediums, such as hard drives, CD-Roms, and flash memory. The use of file folders are the primary source of organization, although applications have been created to aid users in organizing and viewing digital images. Some search engines, such as GOOGLE, also enables users to search for images, primarily by matching text-based search input to text metadata or content associated with images.

### SUMMARY OF THE INVENTION

The present invention relates generally to a computer-implemented method and system for generating recommendations of style. In one preferred embodiment, this recommendation of style may include a recommendation for an article of clothing wherein the recommendation may include elements of fit, cut, label, etc.

### DESCRIPTION OF THE DRAWINGS

In the accompanying drawings:

FIG. 1 illustrates a simplified system for performing similarity searching of persons using various kinds of information, according to an embodiment of the invention; and

FIG. 2 illustrates components for use in enabling similarity searches of persons, according to one or more embodiments of the invention.

### DESCRIPTION OF EMBODIMENTS

In the following description, for purposes of explanation, numerous specific details are set forth in order to provide a thorough understanding of the invention. It will be apparent, however, to one skilled in the art that the invention can be practiced without these specific details. In other instances, structures and devices are shown in block or flow diagram form only in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not others.

Moreover, although the following description contains many specifics for the purposes of illustration, anyone skilled in the art will appreciate that many variations and/or alterations to the details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

Embodiments described herein provide a system and method for performing similarity searches or comparisons of people in order to view and make style choices based on the style of others. More specifically, embodiments described herein provide for performing similarity matching to compare images of persons against those of others in order to find persons who are similar in appearance. In one embodiment, consumers are matched with other consumers (including celebrities) based on attributes including height, weight, size, body shape, age, type of job, type of work field, position at work, geographical location etc. Geographical locations may include country, state within a country, city, by zip code, by high school, by college/universities.

Numerous usages for person similarity search exist. The system may utilize social networking sites like Facebook, Pinterest, Twitter, Linkedin, Instagram, etc. to arrive at an appropriate weightage of recommended style options. For example, on a social network site, body similarity characteristics may be used to cluster individuals who are deemed to look like on another, as a means of choosing differences in their wardrobe upon seeing it worn by others with similar body characteristics. For example, a person may seek other persons who resemble a favorite movie star. The similarity search engine may also be used to identify persons who look like one another for purposes of amusement.

One or more embodiments enable person similarity operations to be performed, where a person's body information in an image is used to generate search criteria from which a result of similar physical attributes is programmatically determined. In one embodiment, a person is identified from an image. In particular, a person is identified using text and metadata associated with the image of the person to be identified. A similarity search is then performed using the image of the person in order to identify images of other persons that are similar in appearance to the person in the image. One or more embodiments further provide that at least some of the text and metadata are used to determine one or more classifications for the person in the image. The determined classifications are used as part of the similarity search.

For example, the determined classifications may be used to filter a search result, or enhance determinations made about the image when the image is analyzed. One or more embodiments also provide a system for determining personal similarity. In an embodiment, the system includes an analysis module that is configured to identify (i) a person from an image, and (ii) at least one of text or metadata associated with the person of that image. Additionally, the system may include a characteristic determination module and a comparison module. The characteristic determination module is configured to identify one or more biographical classifications of the person based at least in part on the at least one of the text or metadata associated with that person. The comparison module is configured to compare a query image input of the person with a collection of images of other persons in order to identify one or more people in a collection that are determined as being similar to the person of the query image input. The query image input comprises image data representing the person and the one or more biographical classifications determined about the person using at least the text and metadata.

As used herein, the term “image data” is intended to mean data that corresponds to or is based on discrete portions of a captured image and more specifically refers to images uploaded by users of themselves wearing a particular attire including clothing, accessories, shoes etc. For example, with digital images, such as those provided in a JPEG format, the image data may correspond to data or information about pixels that form the image, or data or information determined from pixels of the image. Another example of “image data” is signature or other non-textual data that represents a classification or identity of an object, as well as a global or local feature. As used herein, “digital closet” refers to an area where a user or person may save all images a user likes that is to be viewed at any time by anyone, and “digital portfolio” refers to an area where a user may save “profile” of other users, so that “the user” is able to receive updates whenever a user in his/her digital portfolio performs an action such as upload their image etc.

The terms “recognize”, or “recognition”, or variants thereof, in the context of an image or image data (e.g. “recognize an image”) is meant to means that a determination is made as to what the image correlates to, represents, identifies, means, and/or a context provided by the image. Recognition does not mean a determination of identity by name, unless stated so expressly, as name identification may require an additional step of correlation.

As used herein, the terms “programmatic”, “programmatically” or variations thereof mean through execution of code, programming or other logic. A programmatic action may be performed with software, firmware or hardware, and generally without user-intervention, albeit not necessarily automatically, as the action may be manually triggered.

One or more embodiments described herein may be implemented using programmatic elements, often referred to as modules or components, although other names may be used. Such programmatic elements may include a program, a subroutine, a portion of a program, or a software component or a hardware component capable of performing one or more stated tasks or functions. As used herein, a module or component, can exist on a hardware component independently of other modules/components or a module/component can be a shared element or process of other modules/components, programs or machines. A module or component may reside on one machine, such as on a client or on a server, or a module/component may be distributed amongst multiple machines, such as on multiple clients or server machines. Any system described may be implemented in whole or in part on a server, or as part of a network service. Alternatively, a system such as described herein may be implemented on a local computer or terminal, in whole or in part. In either case, implementation of system provided for in this application may require use of memory, processors and network resources (including data ports, and signal lines (optical, electrical etc.), unless stated otherwise.

Embodiments described herein generally require the use of computers, including processing and memory resources. For example, systems described herein may be implemented on a server or network service. Such servers may connect and be used by users over networks such as the Internet, or by a combination of networks, such as cellular networks and the Internet. Alternatively, one or more embodiments described herein may be implemented locally, in whole or in part, on computing machines such as desktops, cellular phones, personal digital assistants or laptop computers. Thus, memory, processing and network resources may all be used in connection with the establishment, use or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown in figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums.

Overview

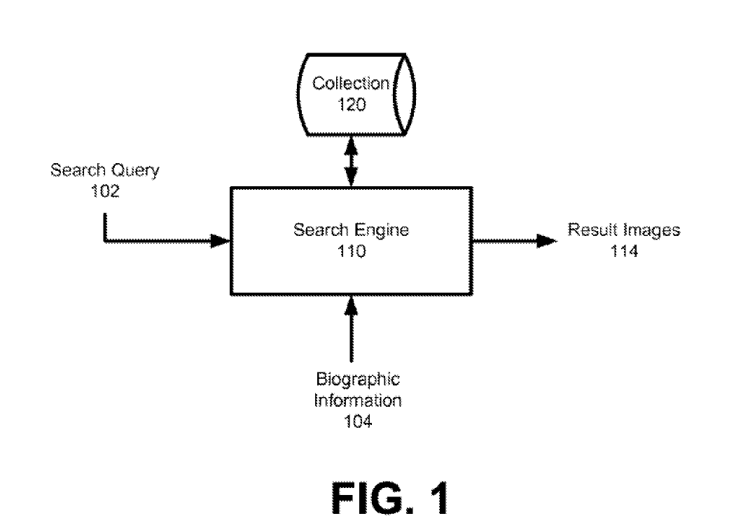

FIG. 1 illustrates a simplified system for performing similarity searching of persons using various kinds of information, according to an embodiment of the invention. In an embodiment, a similarity search engine 110 is adapted or programmed to perform similarity searches of images, and of persons in particular. In an embodiment, a query image input 102 is used as a basis of comparison for finding other persons that have an appearance that is programmatically determined to be similar. Thus, search criteria may be generated to correspond to the query image input 102. The query image input 102 may correspond to an image of a person that is to serve as the basis for comparison. For example, a user of a social network site may use his own image as input, for comparison and identification of other persons who share similarities. The engine 110 may use query image input 102 to generate result images 114, comprising a set of images that are programmatically determined to be similar to the body characteristics of the query image input 102. An embodiment of FIG. 1 assumes engine 110 includes or accesses a collection of images 120 in order to generate or identify the result images 114.

Different types of similarity searches are possible using the system of the present invention. In one embodiment, the query image input 102 is used to match a user to other users based on profile attributes such as height, weight, size and body shape or body type, body structure, age of the user, geographic location, profession of a person, income level of a person etc. In another embodiment, the query image input 102 is based on recognition signatures, which may substantially uniquely identify persons. It is envisioned that when a user first joins the system, the user will enter their profile attributes and is then instantly connected to other users who match the user's profile attributes such as height, size, weight, body shape, age group, profession, job position, student, geographic location (may be narrowed down to city or zip code) or celebrities who match the user's physical profile attributes etc. The system then automatically adds these “matched” user and celebrity profiles to a user's digital portfolio located in that user's designated digital storage medium. The next time a user logs into the system, the user will see the latest images uploaded by these users wherein their profiles have been saved in her/his digital portfolio, respectively.

In one embodiment, the system will display profiles of users depending on age ranges. For example: users in age group 20-27 years will be able to see all profiles of users in age groups 20-27 years & 28-35. Where users in age group 28-35 years will be able to see all profiles of users in age groups 20-27 years, their age group 28-35 and the next age range above 35-45 only. Therefore, age group 28-35 will not be able to see users in an age group less than 20-27. However the age range 35-45 will be able for access and display to users in all age groups. More particularly, users in age group 16-19 years will be able to see all profiles of users in age groups 16-19 and 20-27 years but not that of age group 28-35 and above and below 16-19 years. Lastly, users in age 15 years will be able to see all profiles of users only in age groups 15 years and no other age group.

As another alternative or addition, another feature that may be used by engine 110 to perform similarity searching may correspond to a user's height range to height range; weight-weight, body shape-body shape; age group appropriate as explained above; profession range-profession range; job position-job position; geographic location to geographic location and user profile attributes to celebrity profile attributes of the query image input 102. For instance, the height and the width of a user's body figure, as well as a generalization or quantitative description of an overall head-shape (elongated or round shape) may provide another basis for identifying results 114. This information may be extracted using various means but is mainly arrived at by the user inputting information about their body characteristics upon entering and participating in the style recommendation engine and method of the present invention.

As another alternative or addition, another feature that may be used by engine 110 is to perform day-to-day operations include allowing users to upload images of the themselves wearing outfits taken via mobile, tablets, camera etc. on the system onto their accounts. The user may then browse and save the images of other users in his/her digital portfolio. The user may also choose to follow other (matched or non-matched) users or celebrities' profiles so that the user automatically receive from the engine 110 updates of their latest images (outfits, attire etc.) Additionally, a user may perform some actions on other user's images. For example: If the user likes the way clothing fits on another user, ii) likes the style of clothing, iii) likes clothing by brand, iv) type of clothing or for any other reason, the user can “like” the image, leave a “comment” on the image, or save the image in his/her digital closet.

As still yet another preferred embodiment, a feature that may be used by engine 110 to perform similarity searching is a user's geographical location used as a criterion to match the user to other users as style may vary from one location to another location. To illustrate this type of feature by way of example only is the case where a user A is a business executive woman living in Country A1. She is travelling on a business trip to country B1. Country A1 could be a conservative country, where ethnic attire is normally worn even in business meetings. Country B1 could be a fashion conscious country. User A may want to wear fashionable clothing, that would look smart on her and be appropriate for business meetings in B1.” In yet another example of using this type of feature of engine 110 is illustrated as follows, a user is a graduating 22 year old female, 5′3″, 145 lbs, having a hourglass body shape, starting a new job as a project manager in New York. She does not know what kind of attire is appropriate and what style of clothing would look good on her. She creates an account on the system of the present invention, creates her profile, enter her attributes, instantly gets matched to other users of similar attributes and gets recommendation on what style of attire would look good on her. In another preferred embodiment, the system may her to purchase the item in her size.

As another alternative or addition, another feature that may be used by engine 110 to is to retrieve information from other social networking sites such as Facebook, Twitter, Pinterest, LinkedIn, Instagram and other such social sites for the purpose of more meaningful fashion and style match. Some examples are, the system may retrieve and store user habits, i.e., TV shows, radio programs, songs, record albums, particular artists and actors and movies the user likes as well as user preferences, geographical location, school, other network affiliation, age, likes, recent activity, images viewed, searches etc. and much more variety of information via social network APIs. To incentivize the user to upload more images of themselves thereby building a large database, the system may assign points to the user each time the user interacts with the system. Some examples of system interaction are: a user uploads their own image with a new outfit, the user uploads another user's image and labels it and links it with that user's profile name. This will create a robust database of search-able users wherein both the user and labeled user receive points in an award based program more fully described below.

Another embodiment of the system of the present invention is an award based system where the user reaches a certain milestone of points, the system assigns the user ascending titles, say 500,000 points gets the user “Fashion Sophisticate” title, 750,000 points gets the user “Trendsetter Title”, 1000,000 points gets the user “style Icon” title wherein each title is associated with certain rewards such as a free photo shoot with a photographer, a gift voucher from a store, invitation for girls night out events at retail stores, a day with a celebrity, the user's profile being highlighted on a prime visible spot on the system for a day or even a free trip to a location of their choice, etc.

To make the system more viral and to incentivize users to invite more users, in one embodiment, the system may also include a multi-tier point system. To understand how the multi-point tier system works, consider the scenario where user A invites 10 friends (friends of User A) to join the system. User A gets 100 points for each friend invited who accepts, totaling 1000 points in her point's bank. Each of those 10 friends further invites 10 more friends who join the system. (friends of friends of user A (Fo-Fo-UserA) wherein user A gets 20 points for each Fo-Fo-UserA invited, adding 2000 more points to her point's bank. Each Fo-Fo-User A invites 10 users each. (Fo-Fo-Fo-UserA). Now Fo-Fo-User A gets 30 points each for each of their 2nd tier user invitees. User A gets 15 points for each of Fo-Fo-Fo-User A invited adding 15000 more points to her points bank. User A's points bank now has 1000+2000+15000=18000 points. In summary, each Fo-Fo-User A gets 20 points for each Fo-Fo-Fo-User A invited. Each Fo-Fo-Fo-User A invites 10 more users each (Fo-Fo-Fo-Fo-User A) wherein user A gets 10 points for each invited user who accepts and so forth. After a certain number of tiered leveled invites, the user A keeps getting 5 additional points and for each invited user who joins and then unjoins, points are awarded for joining and subtracted same number of points are subtracted for closing the system account.

Embodiments described herein recognize the value and strength of branding in the clothing fashion industry. Therefore, another feature of the system using engine 110 would be a program that allows the user to perform the function of becoming a “Branding Advocate”. This will work as follows: if a user uploads mostly images of one type of brand, the system may assign him/her the “brand advocate” title for that particular Brand. For example “user A uploads images of themselves wearing Calvin Klein outfits, shoes and/or accessories. The user with this title gets a chance to be a model for that brand, and may earn some money etc., if the brand is running an ad campaign. In one embodiment, to further incentivize users to upload more images of them self and to retain continued user interest in the system, there may be “user contests”. Some examples of this may include: contest for best summer attire by geographic location, (one example is: all users will be eligible to enter this contest, they would upload one image of themselves wearing a summer outfit. All other users may vote each outfit one time. Users cannot vote on their own outfit. The user who gets max votes wins. If there are multiple ties, then those will compete again etc.) Contest for best trendsetter (all users with “trendsetter” title in state of California may compete with each other to win a “state level trendsetter title”, state winner gets to compete in national level trendsetter title and so forth. Contest for best “Brand advocate”. There could be competition between Brand advocates of different brands. Competition between all brand advocates of “same brands” in geographic locations by country (example all Calvin Klein advocates in US vs UK vs France) or a regions (example all Calvin Klein advocates in L.A. vs SF vs NY) and so forth. Brand advocates would be important for monetization as the system may charge brands to pay operators/owners of the system and these advocates to use them as models for their clothing, marketing to advocates' followers etc. (an example of marketing could be special discount offering etc.) etc.

System for Analyzing Content Items Carrying Images

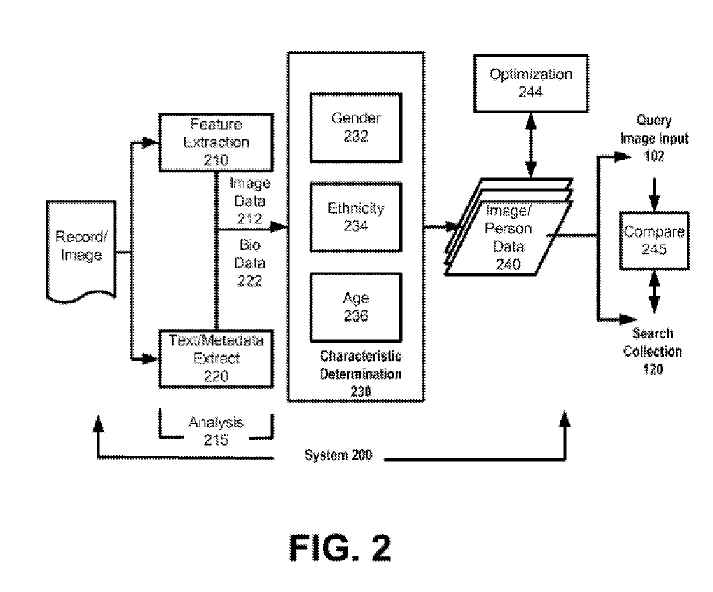

FIG. 2 illustrates components for use in enabling similarity searches of persons, according to one or more embodiments of the invention. A system such as described with an embodiment of FIG. 2 may be used to provide some or all of the functionality of engine 110, as well as to provide data (query image input 102 and collection 120) used by engine 110. Accordingly, a system 200 may include modules that correspond to analysis 215, characteristic determination 230, and comparison 245. The analysis module 215 may include sub-modules or components of feature extraction 210 and text/metadata extraction 220. The input for system 200 may include records 202 that are associated with individuals. For each person, record(s) 202 may include a set of one or more images and text and/or metadata. The input records 202 may be used as part of a backend process to build the collection of records 120 (FIG. 1) that is searched. Additionally, input records 202 may correspond to the query input image 102 (FIG. 1). System 200 may process records 202 as query input image 102 on either a backend process or as a front end process (e.g. on-the-fly).

In an embodiment, system 200 outputs a profile data set 230 for individual persons. The profile data sets 230 are searched for similarities against the query input image 102. According to an embodiment, the profile data set 230 may include (i) image data that represents the image of the record 202, such as images in the form of features as extracted by the extraction module 210; (ii) classifications of gender, ethnicity, age or other biographical classification; and (iii) optionally an identity of the person that is the subject of the record. The comparison module 245 may perform the operations of comparing the profile data set 230 for the query image input 102 (whether retrieved from data store or determined on the fly) against the profile data sets 230 of images in the collection 120. In making a determination of similarity, various parameters may be used as criteria in determining whether individual records or images of collection 120 satisfy a similarity threshold for the query image input 102. One or more embodiments also rank any images in the collection 120 that satisfy the similarity threshold, meaning those images that are deemed most similar may rank higher than other images that satisfy the threshold but are less similar. In one implementation, higher ranked images are displayed first or otherwise more prominently.

The text/metadata extraction 220 identifies and/or extracts text or metadata information that includes biographical information 222. However, embodiments recognize that not all extracted text/metadata may be biographical information 222. As such, extracted words or phrases may initially be viewed as candidates for determining subsequent classifications. The biographical information 222, along with image data 212 (if present), is used by the characteristic determination 230 to generate the profile data set 240 for a person. One or more embodiments provide that the characteristic determination 230 determines gender, ethnicity, and/or age classification.

Embodiments recognize that some records 202 incorporate identity information, meaning information (e.g. full name) that uniquely identifies that person. This information is useful for a variety of purposes. However, if identity information is not available for either the query or result images, automatic labeling can be used as a fall back mechanism. Automatic labeling improves the quality of the similarity features, thereby simplifying indexing and improving the result quality, especially for low quality query images.

Next, computer vision algorithms may be executed on the test images to calculate the visual features, such as gender, ethnicity, hair color, hair length, eye color, with/without eye glasses. An editor interface may be provided to review the results. As described above, the results may be reviewed in groups or clusters. From the biographical information available for a person in an image, one or more embodiments provide for establishing the person's identity (if not already available), gender, and age characteristics.

Any of the embodiments described with FIG. 1 and FIG. 2 may be performed by computers, including general purpose computers, connected (to a network or the Internet) computers, or combinations of client-server computers and/or peer-to-peer terminals. In one embodiment, for example, system 200 is provided on a server, and accessed by a user through a web interface. However, alternatives are possible, including use of standalone computers to provide system 200. In accordance with one deployment, the system may be provisioned as software executing on a server in the cloud. Client device such as mobile phones are provisioned with a client application to connect with the system over a network (e.g. the Internet).

It is contemplated for embodiments of the invention to extend to individual elements and concepts described herein, independently of other concepts, ideas or system, as well as for embodiments to include combinations of elements recited anywhere in this application. Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. This, the absence of describing combinations should not preclude the inventor from claiming rights to such combinations.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, USB and other removable media, hard disk drives, optical disks (e.g., Compact Disk Read-Only Memory (CD ROMS), Digital Versatile Disks, (DVDs), etc.), and flash drives, among others.

Although the present invention has been described with reference to specific exemplary embodiments, it will be evident that the various modification and changes can be made to these embodiments without departing from the broader spirit of the invention. Accordingly, the specification and drawings are to be regarded in an illustrative sense rather than in a restrictive sense.

What is claimed is:

1. A computer-implemented method for generating recommendations of style for a user, the method comprising: identifying a user based on the user inputting appearance information; identifying at least one of text or metadata associated with said appearance information; performing a similarity search using said text or metadata in order to identify images of other persons that are similar in appearance to the user; wherein performing the similarity search includes using at least some of the text and metadata to determine one or more classifications for the person in the image for purposes of displaying to the user a particular clothing style for a particular person.

2. The method of claim 1, wherein identifying at least one of text or metadata associated with the inputted appearance information includes determining biographical information about the user using said text and metadata.

3. The method of claim 1, wherein performing a similarity search using said inputted appearance information includes determining one or more of the classifications corresponding to an ethnicity, a gender or an age classification of the user, using said text and metadata.

4. The method of claim 3, wherein determining one or more of the classifications further comprises using inputted appearance information of the user to determine one or more of the classifications corresponding to the ethnicity, the gender or the age classification.

5. The method of claim 1, wherein said inputted appearance information includes the user uploading an image of themselves.

6. The method of claim 1, wherein performing the similarity search includes formulating a search query that represents one or more body characteristics of the person.

7. The method of 1, wherein performing a similarity search using said inputted appearance information includes (i) determining one or more of the classifications corresponding to an ethnicity, a gender or an age classification of the user, using the text and metadata; and (ii) determining a result by selecting one or more images in a collection of different people that has the same determined classifications.

8. The method of claim 1, wherein identifying at least one of text or metadata associated with the user includes identifying an age range contained in a file that includes the image of a particular person.

9. The method of claim 1, wherein identifying at least of text or metadata associated with said inputted appearance information includes identifying geographical locations.

10. A system for recommending style for a user, the system comprising: an analysis module that is configured to identify (i) appearance information inputted by the user, and (ii) at least one of text or metadata associated with said inputted appearance information; a characteristic determination module that is configured to identify one or more biographical classifications from said appearance information based at least in part on the at least one of said text or metadata associated with the user from said appearance information; a comparison module that compares a query input of the user based on said appearance information with a collection of images having corresponding appearance information of other people in order to identify one or more images in the collection that are determined as being similar to the user of the query input, wherein the query input comprises image data representing the appearance information of other people as well as the one or more biographical classifications determined about said appearance information using at least said text and metadata.

11. The system of claim 10, wherein the one or more biographical determinations include one or more of a gender classification, an ethnicity classification, and an age classification.

12. The system of claim 11, wherein the characteristic determination module is configured to determine any of the one or more biographical classifications using a combination of said text and metadata and further determines geographical locations.

13. The system of claim 10, wherein the comparison module is configured to generate a result of images that includes appearance informations of persons that have all of the one or more biographical classifications.

14. The system of claim 10, further comprising a system that includes an optimization module to optimize one or more operations for determining one or more appearance informations of the images in the collection that are determined to be similar to the appearance information of the query input.

15. The system of claim 14, wherein the optimization module is configured to determine whether a given image in a record is suitable for the query input.

16. The system of claim 14, wherein the optimization module is configured to use an identity of either a person of the query input or of a person in one of the images of the collection in order to determine the one or more appearance informations of the images in the collection that are determined to be similar to the appearance information of the query input.

17. The system of claim 10, wherein the characteristic determination module identifies at least one of text or metadata associated with the image by identifying a text contained in a file that includes the image of the person.

18. The system of claim 10, wherein the characteristic determination module identifies at least one of text or metadata associated geographical regions.

19. A computer-readable medium for determining appearance information similarity, the computer-readable medium comprising instructions, that when executed by one or more processors, cause the one or more processors to perform steps comprising: identifying a person from inputted appearance information; identifying at least one of text or metadata associated with said appearance information; performing a similarity search using said inputted appearance information, in order to identify images of other persons that are similar in appearance to the person's appearance information; and displaying to the person images corresponding to their appearance information.

20. The computer-readable medium according to claim 19 wherein said appearance information includes one or more of a gender classification, an ethnicity classification, an age classification, body characteristics and geographical location.
